(19) United States
(12) Patent Application Publication
(10) Pub. No.: US 2007/0199075 A1
(43) Pub. Date: Aug. 23, 2007

(54) Method of and device for generating authorization status list

(75) Inventors: Boris Skoric, Eindhoven (NL); Antonius Adriaan Maria Staring, Eindhoven (NL); Johan Cornelis Talstra, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/598,936

(22) PCT Filed: Mar. 2, 2005
(86) PCT No.: PCT/IB05/50766

§ 371 Date: Sep. 15, 2006

(30) Foreign Application Priority Data
Mar. 17, 2004 (EP) 04101104.0

(51) Int. Cl. H04L 9/32; H04N 7/16; H04L 9/00; G06F 12/14; G06F 17/30; G06F 7/04; G06F 11/30; G06K 9/00; H04K 1/00; H03M 1/68

(52) U.S. Cl. 726/27; 726/29; 713/193; 713/165; 713/167; 705/51; 713/156; 713/173

(57) ABSTRACT

A method of generating an authorization status list, comprising generating a run-length encoded representation of an authorization status of a number of devices and storing the representation in the authorization status list. Preferably comprises generating the representation by indicating, for each of a number of ranges of devices, the devices in a particular range having a same authorization status, the number of devices in each of said ranges, together with for each of said ranges the authorization status shared by the devices in each of said ranges. A range may then be omitted if it is of a predetermined length.

In recent years, the amount of content protection systems has grown at a rapid pace. Some of these systems only protect the content against illegal copying while others are also prohibiting the user to get access to the content. The first category is called Copy Protection (CP) systems and has been traditionally the main focus for Consumer Electronics (CE) devices, as this type of content protection is thought to be implementable in an inexpensive way and does not need bidirectional interaction with the content provider. Examples are CSS (Content Scrambling System), the protection system of DVD ROM discs and DTCP (Digital Transmission Content Protection), the protection system for IEEE 1394 connections. The second category is known under several names. In the broadcast world they are generally known as CA (Conditional Access) systems, while in the Internet world they are generally known as DRM (Digital Rights Management) systems.

Content protection systems normally involve protected communication between devices based on some secret, only known to devices that were tested and certified to have secure implementations. Knowledge of the secret is tested using an authentication protocol. The best solutions for these protocols are those which employ public key cryptography, which use a pair of two different keys. The secret to be tested is then the secret key of the pair, while the public key can be used to verify the results of the test. To ensure the correctness of the public key and to check whether the key-pair is a legitimate pair of a certified device, the public key is accompanied by a certificate, that is digitally signed by a Certification Authority (CA), the organization which manages the distribution of public/private key-pairs for all devices. Everybody knows the CA's public key and can use it to verify the CA's signature on the certificate. In a simple implementation the public key of the CA is hard-coded into the implementation of the device.

To enable this process each hardware device or software application (referred to collectively as devices hereafter) holds a number of secret keys, sometimes also known as private keys. These keys and the control flow using these keys should be well protected, for knowledge of these keys or manipulation of the control flow would allow hackers to circumvent the content protection systems.

In typical security scenarios, there are several different devices involved, which might not all be implemented with equal levels of tamper-proofing. Such a system should therefore be resistant to the hacking of individual devices, which might enable illegal storing, copying and/or redistribution of digital content. However, it is likely that during the lifetime of a product type that makes use of the system, some or even many devices will get hacked in some way.

An important technique to increase the resistance is the so-called revocation of these hacked devices. This requires all devices to read a so-called Certificate Revocation List (CRL), a list allowing identification of revoked devices. Compliant devices are forced in some manner to possess an up-to-date CRL, and they should never pass content to devices that are listed as revoked in the CRL. The CA generates and distributes new CRLs whenever necessary.

Revocation can be indicated in several different manners. Two different techniques are to use so-called black lists (a list of revoked devices) or white lists (a list of un-revoked devices). Typically all devices in the content protection system have mutually unique identifiers installed in the factory. Alternatively an authorized domain manager device may assign unique identifiers to devices as they join the authorized domain. These identifiers can be used in the CRL instead of globally unique identifiers.

The difference between white lists and black lists lies in their interpretation and use: in order for a “Verifier” to ascertain that a “Prover” wishing to authenticate with the Verifier is indeed not revoked, in the case of black lists, the Verifier will have to obtain the complete blacklist. In the case of white lists, the Verifiers need as proof of non-revocation only that part of the white list that refers to the Public Key or ID of the Prover. Therefore the white list scenario has important advantages in terms of storage and bus-transmission in content protection systems, especially in scenarios such as a PC-host application authenticating to a peripheral device like an optical drive with little computing power: processing.

However, with this advantage comes a disadvantage: simple white-listing requires that every device/application gets its own certificate attesting to its state of non-revocation, with enormous network, or disc-storage overhead.

To mitigate this problem, international patent application WO 003/107588 (attorney docket PHNL020543) and international patent application WO 003/107589 (attorney docket PHNL020544) introduced a Groups Certificate (GC) that is supplied by the Prover to the Verifier. The GC is a concise proof of the fact that one or more groups-to one of which the Prover belongs—is authorized, for example to access certain content under the control of the Verifier or to perform some other operation like logging in to a network. This same GC can be used by many devices/application (in fact all devices/application which are mentioned in the GC).

The group certificates according to these patent applications indicate in one embodiment the upper and lower boundaries of each group represented in the GC. When a device in a particular group loses its status as authorized device, one or more new group certificates have to be generated. Moreover to indicate these boundaries the device identifiers are included. Such identifiers can be very large since they often have to be globally unique. This makes group certificates quite big if there are a large number of groups. Also, parsing these group certificates may be difficult, especially by hardware devices with little memory and computing capacity.

It is an object of the present invention to provide a method of generating an authorization status list which provides on the average a shorter representation of the authorization status of the devices on the list than prior art methods.

This object is achieved according to the invention in a method comprising generating a run-length encoded representation of an authorization status of a number of devices and storing the representation in the authorization status list.

The invention is based in part on the following insights:
With very high probability, recently manufactured devices IDs will be unrevoked.
Software devices are more vulnerable to hacking than hardware. Old software devices are very likely to have the status “revoked”.
When revocation occurs, it will involve legal action. This represents a substantial threshold and therefore the number of revocation events will be limited. Furthermore, the probable outcome of such legal revocation actions is that a single device or a contiguous range of devices (e.g. a model/type from the same manufacturer or software company) will be revoked.
Theft may occur of discs containing new device IDs/Public Keys/Private Keys (typically a block of numbers) for distribution to drive manufacturers and software companies. When this theft is discovered, the Certification Authority revokes all these (contiguous) device IDs.

As a result, authorization status lists are expected to contain:
long ranges of unrevoked devices,
long ranges of revoked devices,
isolated single revoked devices between long ranges of unrevoked devices, and
isolated single unrevoked devices between long ranges of revoked devices.

Run-length encoding will ensure these long ranges of devices all with the same authorization status are efficiently represented.

In an embodiment the method comprises generating the representation by indicating, for each of a number of ranges of devices, the devices in a particular range having a same authorization status, the number of devices in each of said ranges. This is a very efficient way to perform run-length encoding of authorization status information that does not require a lot of processing power for the decoding.

Preferably in the authorization status list for each of said ranges the authorization status shared by the devices in each of said ranges is indicated. This can be done using a single bit, e.g. the binary value ‘1’ indicates the device is not authorized and the binary value ‘0’ indicates the device is authorized.

Preferably in the authorization status list for each of said ranges a boundary of the ranges is indicated, for example a device identifier lowest and/or highest in the ranges. If the ranges are consecutive, the lowest identifier of the lowest range and/or the highest identifier of the highest range can be used. This makes it clear to which devices the list applies.

The list may indicate for plural ranges the respective numbers of devices in each of those ranges. If a second range is successive to a first range, then it should be ensured that the first authorization status differs from the second authorization status. This provides a very efficient run-length coding, because now it is possible to omit the indication of the status information. If the status of one range is known, then the statuses of all others can be derived by their ordering relative to the one range.

Preferably a range is omitted if it is of a predetermined length. Short ranges of revoked devices, especially ranges of length one (i.e. individual revoked devices) are more likely to occur than long ranges. Hence, by omitting indications of such ranges a substantial saving can be achieved. A device parsing the list can derive the status of the device(s) in such a range because it will be preceded and followed by ranges having the same authorization status. This can only occur if there was a range with opposite authorization status, and hence that range must have been omitted.

These and other aspects of the invention will be apparent from and elucidated with reference to the illustrative embodiments shown in the drawings, in which:

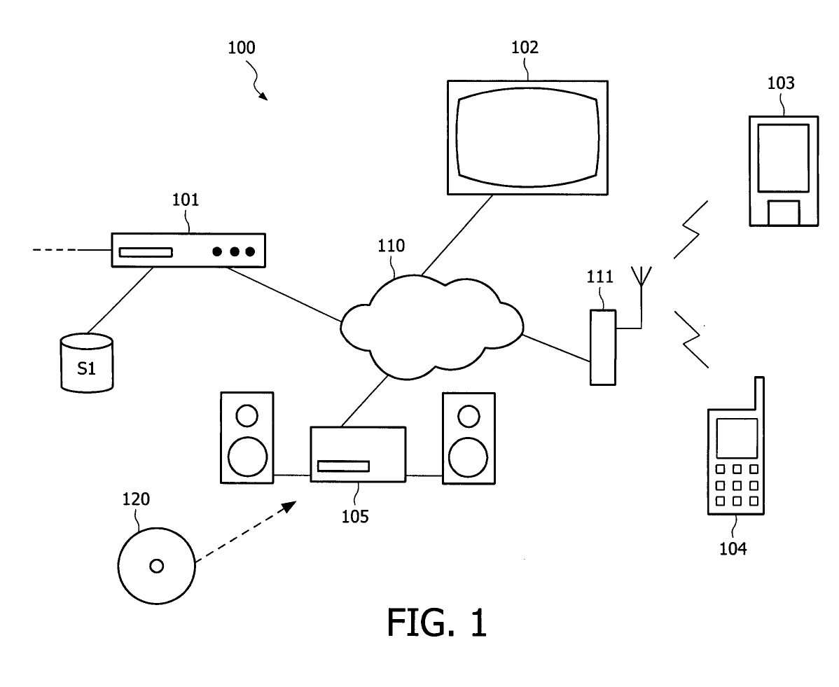

FIG. 1 schematically shows a system comprising devices interconnected via a network;

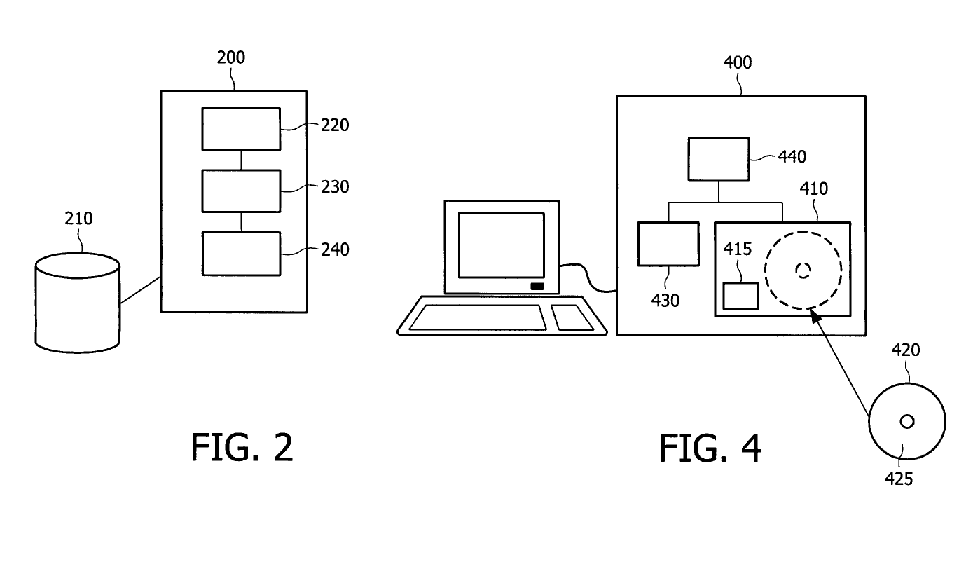

FIG. 2 schematically shows a server arranged to generate an authorization status list in accordance with the invention;

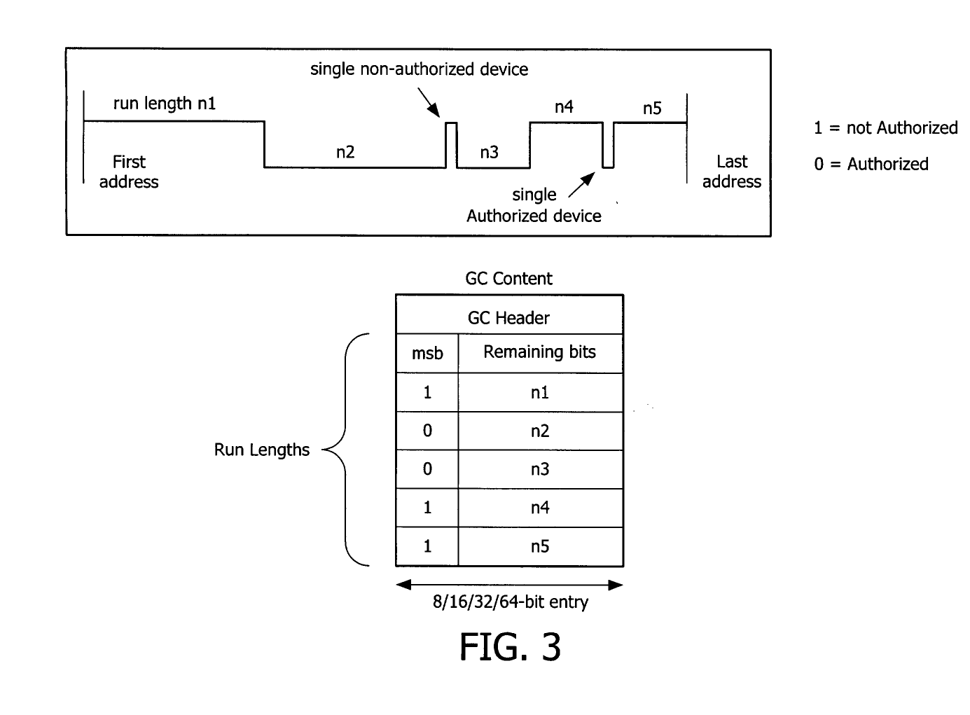

FIG. 3 illustrates a preferred implementation of an authorization status list;

FIG. 4 schematically shows an exemplary embodiment of the invention in which a source device authenticates a sink device; and

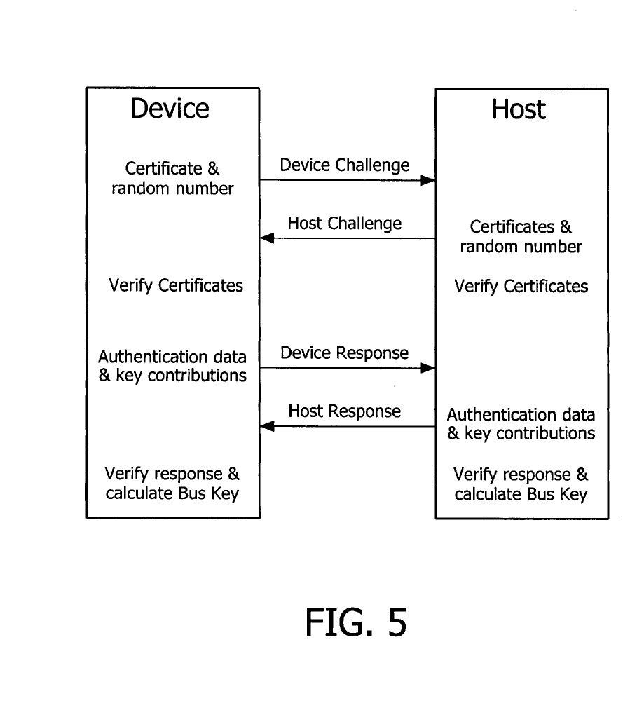

FIG. 5 schematically shows a challenge/response protocol to establish a Secure Authenticated Channel (SAC) which involves the use of an authorization status list in accordance with the invention.

Throughout the figures, same reference numerals indicate similar or corresponding features. Some of the features indicated in the drawings are typically implemented in software, and as such represent software entities, such as software modules or objects.

FIG. 1 schematically shows a system 100 comprising devices 101-105 interconnected via a network 110. A typical digital home network includes a number of devices, e.g. a radio receiver, a tuner/decoder, a CD player, a pair of speakers, a television, a VCR, a digital recorder, a mobile phone, a tape deck, a personal computer, a personal digital assistant, a portable display unit, and so on. These devices are usually interconnected to allow one device, e.g. the television, to control another, e.g. the VCR. One device, such as e.g. the tuner/decoder or a set top box (STB), is usually the central device, providing central control over the others.

The system 100 may be an in-home network that operates as an Authorized Domain. In this kind of content protection systems (like SmartRight from Thomson, or DTCP from DTLA) a set of devices can authenticate each other through a bi-directional connection. Based on this authentication, the devices will trust each other and this will enable them to exchange protected content. In the licenses accompanying the content, it is described which rights the user has and what operations he/she is allowed to perform on the content.

Some particular architectures of authorized domains have been outlined in international patent application WO 03/098931 (attorney docket PHNL020455), European patent application serial number 03100772.7 (attorney docket PHNL030283), European patent application serial number 03102281.7 (attorney docket PHNL030926), European patent application serial number 04100997.8 (attorney docket PHNL040288) and F. Kamperman and W. Jonker, P. Lenoir, and B. vd Heuvel, Secure content management in authorized domains, Proc. IBC2002, pages 467-475, September 2002. Authorized domains need to address issues such as authorized domain identification, device check-in, device check-out, rights check-in, rights check-out, content check-in, content check-out, as well as domain management.

Content, which typically comprises things like music, songs, movies, TV programs, pictures, games, books and the likes, but which also may include interactive services, is received through a residential gateway or set top box 101. Content could also enter the home via other sources, such as storage media like discs or using portable devices. The source could be a connection to a broadband cable network, an Internet connection, a satellite downlink and so on. The content can then be transferred over the network 110 to a sink for rendering. A sink can be, for instance, the television display 102, the portable display device 103, the mobile phone 104 and/or the audio playback device 105.

The exact way in which a content item is rendered depends on the type of device and the type of content. For instance, in a radio receiver, rendering comprises generating audio signals and feeding them to loudspeakers. For a television receiver, rendering generally comprises generating audio and video signals and feeding those to a display screen and loudspeakers. For other types of content a similar appropriate action must be taken. Rendering may also include operations such as decrypting or descrambling a received signal, synchronizing audio and video signals and so on.

The set top box 101, or any other device in the system 100, may comprise a storage medium S1 such as a suitably large hard disk, allowing the recording and later playback of received content. The storage medium S1 could be a Personal Digital Recorder (PDR) of some kind, for example a DVD+RW recorder, to which the set top box 101 is connected. Content can also enter the system 100 stored on a carrier 120 such as a Compact Disc (CD) or Digital Versatile Disc (DVD).

The portable display device 103 and the mobile phone 104 are connected wirelessly to the network 110 using a base station 111, for example using Bluetooth or IEEE 802.11b. The other devices are connected using a conventional wired connection. To allow the devices 101-105 to interact, several interoperability standards are available, which allow different devices to exchange messages and information and to control each other. One well-known standard is the Home Audio/Video Interoperability (HAVi) standard, version 1.0 of which was published in January 2000, and which is available on the Internet at the address http://www.havi.org/. Other well-known standards are the domestic digital bus (D2B) standard, a communications protocol described in IEC 1030 and Universal Plug and Play (http://www.upnp.org).

It is often important to ensure that the devices 101-105 in the home network do not make unauthorized copies of the content. To do this, a security framework, typically referred to as a Digital Rights Management (DRM) system is necessary. One way of protecting content in the form of digital data is to ensure that content will only be transferred between devices 101-105 if
the receiving device has been authenticated as being a compliant device, and
the user of the content has the right to transfer (move and/or copy) that content to another device.

If transfer of content is allowed, this will typically be performed in an encrypted way to make sure that the content cannot be captured illegally in a useful format from the transport channel, such as a bus between a CD-ROM drive and a personal computer (host).

Technology to perform device authentication and encrypted content transfer is available and is called a secure authenticated channel (SAC). In many cases, a SAC is set up using an Authentication and Key Exchange (AKE) protocol that is based on public key cryptography. Standards such as International Standard ISO/IEC 11770-3 and ISO/IEC 9796-2, and public key algorithms such as RSA and hash algorithms like SHA-1 are often used.

FIG. 2 schematically shows a server 200 arranged to generate an authorization status list in accordance with the invention. This list can then subsequently be used by devices such as the devices 101-105 to verify whether their communication partners are still authorized to communicate with them.

The invention assumes that devices have respective identifiers. These identifiers are arranged in a particular ordering. A very straightforward way to do this is to assign the first device the identifier “1”, the second the identifier “2”, and so on. If the device identifiers themselves are noncontiguous, for example if they are randomly chosen alphanumerical strings, a mapping could be made to a sequential ordering.

The authorization status list reflects the authorization status of a number of devices. This number of could be all devices, but is preferably chosen as a subset. If chosen as a subset, it is advantageous to indicate in the list one or both boundaries of the subset, for example the lowest and/or highest device identifiers or the lowest device identifier together with an indication of the size of the subset.

The subset can be chosen to correspond to a predefined group of devices. For example a group of devices manufactured by the same entity, or in a particular period could be covered by a single authorization status list.

For each applicable device identifier the authorization status is determined. This status can be as simple as “authorized” versus “not authorized” or be more complex. For example, an authorization status list could indicate that a particular device should no longer be communicated with at all, or that only content of low value should be supplied to that particular device. If a simple two-state status is used, a single bit can be used in the authorization status list to represent it. The server 200 may comprise a database 210 indicating the authorization status of the devices for which the authorization status list is to be generated.

When a device is “authorized” or not depends on the application. It could mean that it has been established that the device is in compliance with a certain set of requirements or a certain standard. It could mean that the device is authorized to access, copy, move, modify or delete certain content that it may perform some other operation like logging in to a network.

The server 200 then activates run-length encoding module 220 to generate a run-length encoded representation of these authorization statuses. In a preferred embodiment, the module 220 identifies ranges of devices having the same authorization status. A range is a set of successive items in the ordering used for the device identifiers. The module 220 might for example determine that devices with identifiers 1-53 are authorized, devices 54-69 are not authorized, device 70 is authorized, devices 71-89 are not authorized and devices 90-100 are authorized. For each range the module 220 then generates an indication of the number of devices in that range. In the example of the last paragraph, the server 200 would indicate in the authorization status list the numbers 53, 16, 1, 19, 11. It is clear that this form of run-length compression presents a large reduction compared to indicating for each of these 100 devices their status separately.

The encoded representation is then fed to list generation module 230, which creates an authorization status list comprising this encoded representation. Preferably the module 230 indicates with each number the applicable status, for example “1:53, 0:16, 1:1, 0:19, 1:11”. Alternatively an indication could be provided, for example in the header, of the authorization status of the first range indicated. A device parsing this list can then assume that the second range has a status opposite to the indicated status, the third range a status equal to the indicated status, the fourth again opposite and so on. This has the advantage that only a single status indication needs to be provided even when a large number of ranges is included.

It might be agreed upon beforehand that the first range indicated is always to be considered authorized or not authorized. This means that not even a single status indication needs to be provided. However, this creates the problem that the first device in the first range might eventually come to have an authorization opposite to the agreed-upon status. To solve this problem this first identifier could be declared reserved so that it will never be assigned to any devices.

For example, suppose it is agreed upon that the first range indicated is always to be considered authorized. In the beginning, all devices are authorized so that the authorization list could be as simple as “1-100”. At some point in time the first ten device identifiers are to be declared no longer authorized. A new authorization list is then generated, indicating “1, 10, 89”. This can be interpreted as “the first ten device identifiers are not authorized and the next 89 are authorized”, since the very first indication covers only the reserved device identifier.

A further improvement can be obtained by omitting a range of predetermined length. Preferably this predetermined length is chosen to be equal to 1. It may be desirable to indicate in the authorization status list the value of this predetermined length. In the example under discussion, omitting ranges of length 1 would result in indication of “1:53, 0:16, 0:19, 1:11” in the list. The omitted range can be detected from the fact that there have been indicated two consecutive ranges with the same authorization status. If there were no devices in between with a different status, these two ranges could have been indicated as a single range.

The number of devices in a particular range can be indicated using a fixed number of bits. It may be advantageous to have the module 230 determine what the highest number is and to determine the number of bits needed to represent this number. This number of bits can then be indicated in the list. This avoids the situation that for example 32 bits are used to encode each number of devices in each particular range, of which 16 are wasted because no range comprises more than two to the power of 16 devices.

Multiple lists might be combined into a single data element, so that such an element covers multiple nonconsecutive ranges of device identifiers. In this case the header of the data element might provide an indication of the respective ranges covered, for example “1-100, 120-140, 250-290”. This allows easy filtering by devices receiving this data element.

The module 230 might digitally sign the authorization status list or protect it otherwise, for example by attaching a keyed message authentication code (see Internet RFC 2104).

FIG. 3 illustrates a preferred implementation. The authorization status of all devices ranging from “first address” to “last address” has been determined and is shown at the top. There are seven ranges, five of which are labeled n1 through n5. The remaining two are ranges of length 1, indicating single devices between longer ranges. The length of these ranges, together with their applicable status is indicated in the authorization status list shown at the bottom. Each range and status is indicated using a single word that may be 8, 16, 32 or 64 bits. This number of bits might be indicated in the header. The most significant bit (MSB) of each word is used to indicate the authorization status of the devices in the corresponding range. The other bits of each word are used to indicate the length of these ranges. Ranges of length 1 have been omitted.

Optionally the authorization status list can have a monotonically increasing generation or version number, and the devices using the list could then be configured to only accept a list if its generation number is higher than some pre-ordained number, e.g. stored among the content on a disc, or stored in NVRAM on board of the device. As alternative to such a number, a creation date can be used.

Having generated the authorization status list, the server 200 needs to make the information on the list available to the devices 101-105. This can be done in a variety of ways. The server 200 could transmit the list to the devices 101-105 as a signal via a network using network module 240, for example on request from the devices 101-105. The list could also be transmitted periodically. A device that receives the list from the server 200 could transmit the list to other devices to which it is connected. It is preferred that when devices receive authorization status lists, the devices store only the list concerning the group of which they are a member and, accordingly, there is a need for only limited storage size.

The server 200 could also record the list to a storage medium, for example an optical record carrier such as a DVD+RW disk. The medium can then be supplied to devices 101-105. This medium could also hold content, or be dedicated to the storage of authorization status lists.

If the medium is of the rewritable variety, it is preferred to record the list in an area that ordinary consumer-grade rewriter devices cannot modify. Such an area is sometimes known as a “fixed data area”, e.g. as disclosed in international patent application WO 01/095327. To store data in such a fixed area requires the use of components which are typically not available in consumer devices. An example of a technique is to make use of a “wobble”, a radial deviation of the pit positions or the pregroove from a perfect spiral on optical disks. Other examples of data stored in fixed data areas are the BCA code proposed for DVD-ROM, selectively damaged spots on the disc material burned by high-power lasers, or data stored in a special area of the disc which contains read-only material.

International patent application WO 01/095327 also discloses a solution to the problem that the authorization status list might be too large to fit in such a fixed data area. A cryptographic summary, such as an MD5 or SHA-1 hash, of the authorization status list is computed and recorded in the fixed data area. Since such a summary is very short (typically 128 or 160 bits), it can fit easily in the fixed data area. The larger list itself can then be recorded in the rewritable area(s) of the disk. The list is only accepted by a compliant device if a summary computed by the compliant device matches the summary recorded in the fixed data area.

In an alternative solution to this problem, WO 01/095327 suggests to record identification data, e.g. a random number, in the fixed data area. The authorization list, a cryptographic summary thereof and the identification data are digitally signed or protected by a message authentication code and stored in the rewritable area(s) of the disk.

The server 200 is typically embodied as a computer system operated by an entity referred to as Trusted Third Party (TTP), Key Issuance Center (KIC) or Certifying. Authority (CA). Such a computer system operates independently from the network 100. In an alternative embodiment one of the devices 101-105 in the network 100 operates as the server 200 by generating the authorization status list. Preferably the device operating as authorized domain manager generates the authorization status list and makes it available to the other devices in the authorized domain.

The authorized domain manager might receive an authorization status list or revocation list in a non-compressed form or in another form that is not suitable for distribution to the devices in the domain. Such a list can potentially be very large, and the network 100 might have limited bandwidth capabilities, or some of the devices 101-105 might have limited processing capabilities and be unable to process such a large list. In cases like that it is advantageous that the authorized domain manager generates an authorization status list in accordance with the present invention from authorization information received from an external source.

This generating of a “local” authorization status list could be done by selecting from the “global” authorization status list only that information which applies to devices in the domain. The domain manager might know for example which device identifiers the devices in the domain have. It can then scan the global list for those identifiers and generate a local authorization status list covering those identifiers. The domain manager might digitally sign the local authorization status list or protect it otherwise, for example by attaching a keyed message authentication code (see Internet RFC 2104). This allows the devices in the network 100 to accept the local authorization status list as authentic.

The domain manager may have assigned the devices that joined the domain in a local device identifier. In that case, the local authorization status list could be based on these local device identifiers instead of the global device identifiers. This has the advantage that local device identifiers are typically chosen from a smaller range than global device identifiers, which means that the authorization status list will now be much smaller.

In a further optimization scheme, the message part of the certificate is compressed. Signatures of messages with length m<C can have the property that the message can be retrieved from just the signature itself! Naively one might think that it is no longer necessary to include the group-IDs themselves into the message-part of the certificate. However, filtering certificates, i.e., deciding which certificate must go to which device, e.g. by a gateway device, becomes then very difficult/costly, because signature processing is very expensive and would have to be done for every certificate.

To help such a filtering device the following is proposed: the message part of the certificate only needs to contain the “lowest” and “highest” group-IDs present in the group-of-groups (where “lowest” and “highest” are determined relative to the ordering relation). This allows the filter to decide whether this certificate might contain a relevant group-ID. This can then be verified by the destination device itself inspecting the signature. It allows the rapid rejection of the bulk of certificates that are irrelevant.

An exemplary embodiment in which a source device authenticates a sink device is illustrated in FIG. 4. In FIG. 4, the source device is a DVD reading/writing (DVD+RW) drive 410 installed in the sink device which is a personal computer 400. The source device 410 controls access to content 425 such as a movie recorded on a DVD disc 420. An application 430 running on the personal computer 400 wants to access this content 425. To this end it must communicate with the source device 410, typically via the operating system 440 which interfaces between the various components in the personal computer 400. As the content is protected, the source device 410 will only grant the requested access if it can successfully authenticate the sink device 400. Granting access may involve supplying the content over a bus in the personal computer 400 to the application 430 in protected or in unprotected form.

As part of the authorization of access to the content 425, the usage rights information may need to be updated. For example, a counter indicating how many times the content may be accessed may need to be decreased. A one-time playback right may need to be deleted or have its status set to ‘invalid’ or ‘used’. A so-called ticket could also be used. See U.S. Pat. No. 6,601,046 (attorney docket PHA 23636) for more information on ticket-based access. This updating of the usage rights may be done by the source device 410 or by the sink device 400.

In this authentication process, the source device 410 verifies the revocation status of the sink device 400. To this end it comprises an authorization status checking module 415, typically embodied as a software program. The authorization status checking module 415 parses the authorization status list to determine whether the sink device 400 is authorized. To do this the module 415 must know a device identifier for the sink device 400. The sink device 400 may have presented a certificate signed by an authority trusted by the source device 410, which certificate contained this device identifier. Other ways to learn a device identifier are of course also possible.

The module 415 then selects an authorization status list which covers this device identifier, for example by parsing a header of this list to determine whether this device identifier is comprised between the lowest and highest device identifiers indicated in this header. The necessary authorization status list may be obtained in a variety of ways. It may have been supplied by the sink device 400. It could have been read from a storage medium. It may have been received from the server 200, for example in response to a request by the device 410.

In a preferred embodiment the “prover” (the sink device 400) presents two digitally signed certificates: the latest authorization status list, which shows that a group of which the prover is a member, has not been revoked, and a certificate (installed in the factory), that confirms its Device ID (i.e., that this device is a member of the group mentioned in the step regarding the latest revocation message).

Typically, such a certificate contains a Device ID i and a public key PKi. An attacker having intercepted a certificate for a group of which i is a member and trying to now impersonate i, will not have the secret key SKi corresponding to PKi and all further communication will be aborted when this is detected by the verifier.

Subsequently the module 415 determines in which range the device identifier falls. This can be done in many ways. One way is to determine an offset between this device identifier and the lowest device identifier applicable to the authorization status list in question. The module 415 then can add up the lengths of the ranges as given in the list until the some reaches or exceeds the offset. Another way is to add the lengths of the ranges to the lowest device identifier applicable until the sum equals or exceeds the device identifier for the sink device 400. In both cases, the range whose length was last added to the sum then is the applicable range.

In case ranges of predetermined length are omitted the module 415 needs to add this predetermined length whenever it encounters a second range having the same authorization status as the range whose length just was added to the sum.

A preferred way to implement authorization status lists is now discussed. Authorized Groups Lists (AGLs) are distributed by a Key Issuance Center. An AGL shows the authorization status of all Devices and Applications (with ID=0 . . . 2⁴⁰−1). The AGL is divided into Authorized Groups Certificates (AGCs). Each AGC covers a subrange of the AGL, viz. range of devices with contiguous IDs.

The authorization status of the devices in this range is specified in each AGC listing the run lengths of intervals in which the authorization status for IDs is identical. Each run length is preceded by a 1-bit flag that specifies the status (0=Authorized to establish a SAC, 1=other). The “other” status can indicate e.g. that a device has been revoked or its status is unknown.

To encode short runs efficiently, two consecutive runs with the same flag value shall indicate that a short interval with the opposite status exists between the two runs. The structure of the certificate data field in AGCs is defined in the table below:

| | | |
|---|---|---|
| Syntax | No. of bytes | Mnemonic |

CertificateData( ) {

| | | |
|---|---|---|
| AGCSeqNo | 4 | uimsbf |
| First address | 5 | uimsbf |
| Last address | 5 | uimsbf |
| AGC_Format( ) | 1 | |
| Description of run lengths | variable | |

}

The AGCSeqNo field contains the Sequence Number of the AGC. The First address is the ID of the first device covered in the AGC. The Last address is the ID of the last device covered in the AGC. The number of bytes that is to be used for the description of run lengths is specified by the AGC_Format field.

A SAC shall be established using a challenge/response protocol shown schematically in FIG. 5. In the first step of this protocol, the Host and the Device exchange a challenge. The challenge contains Certificates and a random number. In the second step, both the Host and the Device check the authorization of the other's Public Key Certificate (PKC) by verifying that the ID, contained in the PKC, appears on a valid AGC. Valid in this context means that a sequence number denoted as ProverAGCSeqNo is greater than or equal to a sequence number denoted as VerifierSeqNo, whereby the Verifier checks the freshness of an AGC provided by the Prover and whether the ID of the Prover PKC is actually covered by the AGC. Both Device and Host alternately fulfill the role of Verifier/Prover. On every disc, an Authorized Groups List (AGL) is stored. The AGL contains a complete set of AGCs, provided by the KIC. A VerifierSeqNo can be obtained from several sources:
discs
other compliant devices
network connections

In the third step, both the Host and the Device generate a response to the challenge. Subsequently, both the Host and the Device check the received response. Authentication is successful only if the response is correct. In the last step, both the Host and the Device calculate a Bus Key from data in the response. Only the Device and the Host know the Bus Key. The Bus Key is used to encrypt data that is transferred over the SAC after completion of the SAC establishment protocol.

It should be noted that the above-mentioned embodiments illustrate rather than limit the invention, and that those skilled in the art will be able to design many alternative embodiments without departing from the scope of the appended claims.

International patent application WO 01/42886 (attorney docket PHA 23871) discloses an efficient way of combining a contact list and a revocation list. Contact lists can be combined with revocation lists according to the present invention.

To allow (prospective) owners of such devices to determine the revocation status of their equipment, the method according to international patent application WO 03/019438 (attorney docket PHNL010605) can be used.

European patent application serial number 04100215.5 (attorney docket PHNL040086) describes a method of and source device for authorizing access to content by a sink device in accordance with usage rights, the content being stored on a storage medium controlled by the source device. The revocation status of the sink device is verified using the most recently issued revocation information that is available if the usage rights need to be modified as part of the authorization of access to the content, and using revocation information associated with the content stored on the storage medium, preferably the revocation information stored on the storage medium, otherwise. The revocation information on the storage medium, or only the part relating to the sink device, is optionally updated to the most recently issued revocation information if the usage rights need to be modified. Preferably this is done only if the result of the verification is that the sink device has been revoked. The revocation information as used in this patent application could be prepared in accordance with the present invention.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer.

In the device claim enumerating several means, several of these means can be embodied by one and the same item of hardware. The mere fact that certain measures are recited in mutually different dependent claims does not indicate that a combination of these measures cannot be used to advantage.

1. A method of generating an authorization status list, comprising generating a run-length encoded representation of an authorization status of a number of devices and storing the representation in the authorization status list.

2. The method of claim 1, comprising generating the representation by indicating, for each of a number of ranges of devices, the devices in a particular range having a same authorization status, the number of devices in each of said ranges.

3. The method of claim 2, comprising indicating in the authorization status list for each of said ranges the authorization status shared by the devices in each of said ranges.

4. The method of claim 2 or 3, comprising indicating in the authorization status list a boundary of said ranges.

5. The method of claim 4, comprising indicating as boundary a device identifier lowest and/or highest in the ranges.

6. The method of any previous claim, comprising generating the representation by indicating, for a first range of devices, the devices in the first range having a same first authorization status, the number of devices in the first range, and, for a second range of devices, the devices in the second range having a same second authorization status, the number of devices in the second range.

7. The method of claim 6, the second range being successive to the first range and the first authorization status differing from the second authorization status.

8. The method of claim 6, comprising omitting a further range if the further range is of a predetermined length.

9. The method of claim 8, in which the predetermined length equals one.

10. The method of claim 8, comprising indicating in the authorization status list the predetermined length.

11. The method of claim 2, comprising indicating in the authorization status list a number of bits used to indicate the number of devices in each of said ranges.

12. The method of any previous claim, comprising indicating in the authorization status list a version number and/or a creation date.

13. The method of any previous claim, comprising transmitting the authorization status list to a device for enabling the device to verify the authorization status of itself or of a further device.

14. The method of any previous claim, comprising recording the authorization status list on a storage medium.

15. The method of claim 14, comprising recording the authorization status list in a fixed data area of a rewritable storage medium.

16. The method of claim 14, comprising recording the authorization status list in a rewritable area of a rewritable storage medium and recording a cryptographic summary of the authorization status list in a fixed data area of said rewritable storage medium.

17. A device arranged for executing the method of claim 1.

18. A computer program for causing a processor to execute the method of claim 1.

19. A source device (410) arranged for authorizing an operation by a sink device (400), the source device comprising authorization status checking means (415) for verifying the authorization status of the sink device using an authorization status list as produced by the method of claim 1.

20. A record carrier on which there is recorded an authorization status list as produced by the method of claim 1.

21. The record carrier of claim 20, comprising a fixed data area and a rewritable data area, in which the authorization status list is recorded in the fixed data area.

22. The record carrier of claim 20, comprising a fixed data area and a rewritable data area, in which the authorization status list is recorded in the rewritable area and a cryptographic summary of the authorization status list is recorded in the fixed data area.

23. A signal embodying an authorization status list as produced by the method of claim 1.
